(19) United States
(12) Patent Application Publication
(10) Pub. No.: US 2025/0153475 A1
(43) Pub. Date: May 15, 2025

(54) FIRE RESISTANT COMPOSITE

(71) Applicant: Milliken & Company, Spartanburg, SC (US)

(72) Inventors: Shulong Li, Spartanburg, SC (US); Todd Moore, Spartanburg, SC (US); David Eskew, Charlotte, NC (US)

(21) Appl. No.: 18/939,778

(22) Filed: Nov. 7, 2024

Related U.S. Application Data
(60) Provisional application No. 63/597,562, filed on Nov. 9, 2023.
(60) Provisional application No. 63/597,570, filed on Nov. 9, 2023.
(60) Provisional application No. 63/597,574, filed on Nov. 9, 2023.
(60) Provisional application No. 63/669,961, filed on Jul. 11, 2024.
(60) Provisional application No. 63/669,965, filed on Jul. 11, 2024.

(51) Int. Cl. B32B 27/12; B32B 5/02; B32B 7/12; B32B 27/40

(52) U.S. Cl. CPC B32B 27/12; B32B 5/022; B32B 5/024; B32B 7/12; B32B 27/40; B32B 2255/02; B32B 2255/24; B32B 2262/0269; B32B 2305/188; B32B 2305/20; B32B 2307/3065; B32B 2307/71; B32B 2307/728; B32B 2307/7376; B32B 2375/00; B32B 2437/00

(57) ABSTRACT

The application relates to a fire resistant composite containing a first textile, a first adhesive layer, a polyurethane membrane, a second adhesive layer, and a nonwoven textile. The first textile contains at least about 40% by weight inherently flame resistant fibers. The polyurethane membrane has a softening temperature of least about 210° C. according to ASTM E2347 test method and is non-melting according to ASTM F2894 test method. The polyurethane membrane contains a phosphor-based flame retardant. The nonwoven textile is a spunlace nonwoven textile and contains a plurality of staple fibers being at least about 40% by weight inherently flame resistant fibers. The second adhesive layer contains a discontinuous coating of a hot melt adhesive in a pattern of discrete elements, where the average distance between one element and a neighboring element is less than 1/10^{th} the average fiber length of the fibers in the nonwoven textile.

### RELATED APPLICATIONS

This application claims priority to co-pending U.S. provisional applications 63/597,562 (filed Nov. 9, 2023), 63/597,57 (filed Nov. 9, 2023), 63/597,574 (filed Nov. 9, 2023), 63/669,961 (filed Jul. 11, 2024), and 63/669,965 (filed Jul. 11, 2024), the contents of all of the applications are herein incorporated by reference.

### TECHNICAL FIELD

This application relates to fire resistant composites, more particularly to fire resistant composite contain textiles and membranes.

### BACKGROUND

Outdoor jackets are typically made as two- or three-layer composites where a film is laminated on to an exterior textile or a film is sandwiched between two layers of textile in a lamination process. Current products in the market are predominated with extruded ePTFE (expanded polytetrafluorethylene) films. This approach has a drawback from a sustainability point of view and from people wishing to move away from fluorinated products. There remains a need for an environmentally friendly, high performance composite that is also fire resistant.

### BRIEF SUMMARY OF THE INVENTION

The application relates to a fire resistant composite containing a first textile, a first adhesive layer, a polyurethane membrane, a second adhesive layer, and a nonwoven textile. The first textile has a first surface and a second surface and a plurality of interstices. The first textile contains at least about 40% by weight inherently flame resistant fibers. The polyurethane membrane is on the second surface of the first textile and has a softening temperature of least about 210° C. according to ASTM E2347 test method and is non-melting according to ASTM F2894 test method. The polyurethane membrane contains a phosphor-based flame retardant. The first adhesive layer is located between the polyurethane membrane and the first textile. The nonwoven textile is located on the polyurethane membrane opposite to the first textile. The nonwoven textile is a spunlace nonwoven textile and contains a plurality of staple fibers being at least about 40% by weight inherently flame resistant fibers. The inherently flame resistant fibers have an average staple length of between about 20 and 60 mm. The nonwoven textile has an areal weight of between about 0.2 and 2 oz/yd². The second adhesive layer is located between the polyurethane membrane and the nonwoven textile and contains a discontinuous coating of a hot melt adhesive in a pattern of discrete elements, where the average distance between one element and a neighboring element is less than 1/10^{th} the average fiber length of the fibers in the nonwoven textile.

### BRIEF DESCRIPTION OF THE DRAWINGS

FIG. 1 illustrates one embodiment of the fire resistant composite.

FIG. 2 illustrates an alternative embodiment of the fire resistant composite including a nonwoven layer.

FIG. 3 illustrates an alternative embodiment of the fire resistant composite including a nonwoven layer and adhesive layers.

FIGS. 4 and 5 are softening point curves for polyurethanes used in the examples.

### DETAILED DESCRIPTION OF THE INVENTION

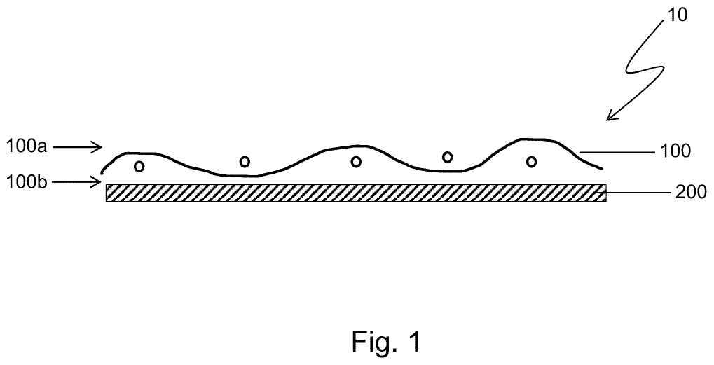

Referring now to FIG. 1, there is shown one embodiment of the fire resistant composite 10 of the invention having a first textile 100 and a membrane 200. For this application “fire resistant” and “flame resistant” are defined as property of any material, composite or component of a composite that exhibits less than 2 seconds afterflame time and less than about 4 inches char length when tested according to ASTM D6413 method and may be used interchangeably. The first textile 100 has an upper side 100a and a lower side 100b and the membrane 200 is attached to the lower side 100b of the first textile 100. The composite 10 preferably has an areal weight of between about 2 and 8 oz/yd², more preferably between about 2.5 and 6.0 oz/yd².

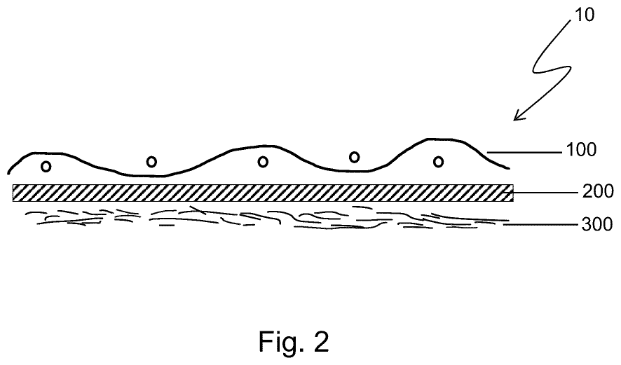

FIG. 2 shows an alternate embodiment of the fire resistant composite 10 of the invention having a first textile 100, a membrane 200, and a nonwoven or knit textile 300. The first textile 100 has an upper side 100a and a lower side 100b and the membrane 200 is attached to the lower side 100b of the first textile 100. The nonwoven or knit textile 300 has an upper side 300a and a lower side 300b and the membrane 200 is attached to the upper side 300a of the nonwoven or knit textile 300.

The first textile 100 can have any suitable construction including woven, knit, or nonwoven. In one embodiment, the first textile is a woven textile. The first textile 100 has an upper side 100a and a lower side 100b. The first textile contains yarns and/or fibers. If the textile is a woven or a knit textile, the textile is made by weaving or knitting yarns, where those yarns contain fibers. If the first textile is a nonwoven, the nonwoven is made typically by entangling fibers to form the textile.

In one embodiment, the first textile 100 is a woven textile which may be, for example, plain, satin, twill, basket, poplin, jacquard, or crepe. In this application, textile and fabric is defined to mean the same and the terms may be used interchangeably. Suitable plain weaves include, but are not limited to, rip stop weaves produced by incorporating, at regular intervals, extra yarns or reinforcement yarns in the warp, fill, or both the warp and fill of the textile material during formation. Suitable twill weaves include both warp-faced and fill-faced twill weaves, such as 2/1, 3/1, 3/2, 4/1, 1/2, 1/3, or 1/4 twill weaves. In certain embodiments of the invention, such as when the textile material is formed from two or more pluralities or different types of yarns, the yarns are disposed in a pattern-wise arrangement in which one of the yarns is predominantly disposed on one surface of the textile material. In other words, one surface of the textile material is predominantly formed by one yarn type. Suitable pattern-wise arrangements or constructions that provide such a textile material include, but are not limited to, satin weaves, sateen weaves, and twill weaves in which, on a single surface of the textile, the fill yarn floats, and the warp yarn floats are of different lengths.

In another embodiment, the first textile 100 is a knit textile, for example a circular knit, reverse plaited circular knit, double knit, single jersey knit, two-end fleece knit, three-end fleece knit, terry knit, tricot knit or double loop knit, weft inserted warp knit, warp knit, and warp knit with or without a micro-denier face.

In another embodiment, the first textile 100 is a multi-axial, such as a tri-axial textile (knit, woven, or nonwoven). In another embodiment, the first textile 100 is a bias textile. In another embodiment, the first textile is a unidirectional textile and may have overlapping yarns or may have gaps between the yarns.

In another embodiment, the first textile 100 is a nonwoven textile. The term “nonwoven” refers to structures incorporating a mass of yarns or fibers that are entangled and/or heat fused to provide a coordinated structure with a degree of internal coherency. Nonwoven textile may be formed from many processes such as for example, melt spun processes, hydroentangeling processes, mechanically entangled processes, stitch-bonding processes, and the like.

In some embodiments, the first textile 100 contains any yarns which may be any suitable yarn. “Yarn”, in this application, as used herein includes a monofilament elongated body, a multifilament elongated body, ribbon, strip, yarn, tape, fiber and the like. The first textile 100 may contain one type of yarn or a plurality of any one or combination of the above. The yarns may be of any suitable form such as spun staple yarn, monofilament, or multifilament, single component, bi-component, or multi-component, and have any suitable cross-section shape such as circular, multi-lobal, square or rectangular (tape), and oval. The first textile 100 can be formed from a single plurality or type of yarn or the textile can be formed from several pluralities or different types of yarns.

The first textile 100 preferably contains inherently flame resistant fibers. As utilized herein, the term “inherent flame resistant fibers” refers to synthetic fibers which, due to the chemical composition of the material/fiber from which they are made or the fiber structure, exhibit flame resistance without the need for an additional flame retardant treatment or coating. In such embodiments, the inherent flame resistant fibers can be any suitable inherent flame resistant fibers, such as polyoxadiazole fibers, polysulfonamide fibers, poly(benzimidazole) fibers, poly(phenylenesulfide) fibers, meta-aramid fibers, para-aramid fibers, polypyridobisimidazole fibers, polybenzylthiazole fibers, polybenzyloxazole fibers, melamine-formaldehyde polymer fibers, phenol-formaldehyde polymer fibers, oxidized polyacrylonitrile fibers, flame resistant modacrylic fibers, flame-retardant-containing cellulosic fibers, polyamide-imide fibers and combinations, mixtures, or blends thereof. In certain embodiments, the inherent flame resistant fibers are preferably selected from the group consisting of polyoxadiazole fibers, polysulfonamide fibers, poly(benzimidazole) fibers, poly(phenylenesulfide) fibers, meta-aramid fibers, para-aramid fibers, oxidized polyacrylonitrile, flame resistant modacrylic and combinations, mixtures, or blends thereof.

In a preferred embodiment, the first textile 100 contains a blend of inherently flame resistant fibers, and optionally other fibers, such that the resulting textile from the blended fibers exhibits flame resistance property. Flame resistance property herein refers to less than 2 seconds afterflame and less than 4 inches char length when tested according to ASTM D6413, Standard Test Method for Flame Resistance of Textiles (Vertical Test). In one embodiment, the first textile contains at least about 40% by weight of inherently flame resistant fibers. More preferably, the first textile 100 contains at least about 45%, 50%, 60%, 70%, 80%, or 90% by weight of inherently flame resistant fibers. These high amounts of inherently flame resistant fibers help make the flame resistant composite resist flames and fire. In a preferred embodiment, the woven textile contains at least about 60% by weight aramid fibers, more preferably at least about 80% by weight aramid fibers. In one embodiment, the aramid fibers in the first textile contain between about 40 and 75% by weight meta-aramid fibers and about 25 and 60% by weight para-aramid fibers. In another embodiment, the aramid fibers in the first textile contain between about 70 and 98% by weight meta-aramid fibers and about 2 and 30% by weight para-aramid fibers. In one preferred embodiment, the first textile is a woven textile made of about 92% by weight meta-aramid fibers, 5% by weight para-aramid fibers, and 2% antistatic nylon fibers. The first textile preferably has an areal weight of between about 2 and 8 oz/yd², more preferably between about 2.5 and 5.0 oz/yd².

In one embodiment, the fire resistant composite contains a fire resistant coating on the first textile. This is not shown in the figures as it is a very thin coating that would not be easily seen in a cross-section of the composite or the “coating” permeate into the textile and/or fiber structure. The fire resistant coating is located on at least the first surface of the first textile and in at least a portion of the interstices of the first textile. The interstices are the spaces between the yarns and fibers within the first textile. The fire resistant coating may penetrate at least partially into the interior structure of the individual fibers of the first textile. In a preferred embodiment, the fire resistant coating is dip coated onto the first textile meaning that the first textile is submerged into the coating liquid. In this embodiment, a majority (greater than about 50%) of the surfaces of the yarns and fibers are coated with the fire resistant coating. Depending on how tightly twisted and bundled the fibers are within a yarn will affect how much of the coating solution reaches the interior of the yarns. In one embodiment, the fire resistant coating may be an adhesive coating comprising a flame retardant composition applied in a continuous or a discontinuous pattern on the first textile.

As the first textile contains inherently flame resistant fibers, the first textile by itself generally exhibits flame resistant properties. There is generally no need or motivation to further treat or coat a textile comprising inherently flame resistant fiber(s) with a flame resistant coating or finish for most applications. There have not been available flame retardant compositions designed or synthetized for inherently flame resistant fibers, for similar reasons. Additionally, process of treating a flame resistant textile comprising inherently flame resistant fiber(s) are generally not needed or known. More importantly, flame retardant coating or finishes not designed for inherently flame resistant fibers, applied to the textile using a general process generally do not achieve a durable or desirable properties. Such coating or finish either do not improve a textile with existing inherent flame resistance, or such coating lack durability to washing. Such coating could adversely affect textile properties, such as making a textile very stiff, discolorations, degradation in mechanical strength. For reasons mentioned above, there have not been commercial flame resistant compositions, process, or motivations to apply a flame resistant coating to a textile comprising an inherently flame resistant fiber. To save cost and to avoid potential adverse effects, people would generally avoid apply a flame resistant coating to a textile comprising an inherently flame resistant fiber.

In one example, when a polyvinyl chloride flame retardant coating was applied to the same textile above, the textile became very stiff. The coating also decomposes at temperatures around 350° F. to generate fiber degrading and corrosive hydrogen chloride, thus adversely affect the temperature stability of the coating textile composite.

When a textile comprising an inherent flame resistant fiber is combined with a non-flame resistant membrane, the resulting composite may not exhibit flame resistant properties, especially when the membrane is a separate continuous layer that is discontinuously attached to the textile. Conventionally approach typically involve adding a flame retardant composition to the membrane to render the membrane layer flame resistant. Although generally successful, adding a flame retardant component to the membrane sometimes can adversely affect other desirable properties provided by the membrane, such as elasticity, strength, and breathability.

Applying certain fire resistant coating composition on the textile was found by the applicant to enable the textile-membrane composite to exhibit resistant properties, even when the fire resistant coating is not in intimate contact with the non-flame resistant membrane layer.

In one embodiment, the fire resistant coating contains a flame retardant composition. The flame retardant composition preferably is a phosphor-based flame retardant. It may include an organic phosphate ester such as a cyclic phosphate ester or organic phosphinate or phosphonates, including phosphorus polyols. Organic phosphate esters includes, but not limited to, acyl and aryl cyclic phosphates, Isopropyl phenyl diphenyl phosphate, resorcinol bis(diphenyl phosphate), triphenyl phosphate, bisphenol A bis(diphenylphosphate), trioctyl phosphate, cresyl diphenyl phosphate, tricresyl phosphate, and trixylyl phosphate. When such coating combination is applied to the textile, the coating is further heat treated at a temperature at least 370° F. such that the flame retardant molecules in the coating penetrate at least partially into the fiber structure to be “fixed”, thus providing durability to laundry. After the coating and heat treatment, the fibers of the textiles contain at least a portion of a flame retardant composition within the fiber interior structure. When the coating is not heat treated at a temperature at 370° F. or above, the coating might not exhibit wash durability and can be easily removed in a regular laundry cycle.

In another embodiment, the flame retardant composition contains a reaction product of organic phosphor-containing compound and a nitrogen-containing compound, herein referred to as a phosphorus-nitrogen compound. The phosphor-containing compound is preferably a tetrakis(hydroxymethylphosphonium) salt. The nitrogen compound contains ammonia, urea, alkyl substituted urea (such as ethylene urea and propylene urea), amines (such as ethylene diamine and melamine), amides, organic azides (such hydrazine, carbohydrazide, and alkylazides), guanidines (such as amino-guanidines), and any mixture thereof. Tetrakis(hydroxymethylphosphonium) salt may react with the nitrogen compound to form a phosphonium-nitrogen product. The phosphonium-nitrogen compound may be oxidized by reaction with an oxidizing agent such as hydrogen peroxide to form a phosphinate-nitrogen compound (or phosphine oxide-nitrogen product). The phosphorus-nitrogen compound may be a reaction product of phosphinic acid, phosphonic acid or phosphoric acid with amines (such as melamine), urea, or amide. Examples of such product includes melamine phosphate, urea phosphate, melamine polyphosphate, and ammonium polyphosphate. The phosphorus-nitrogen compound derived from reaction product of organic phosphor-containing compound and nitrogen-containing compound can be a phosphonium-nitrogen compound, a phosphonate-nitrogen compound, an organic phosphinate-nitrogen compound, a phosphate amide compound, a phosphine oxide-nitrogen compound and a mixture of the above compounds.

Tetrakis (hydroxymethylphosphonium) salt and nitrogen compound can be combined or mixed into a treatment solution before applied to the flame resistant textile by coating, spray or impregnation. Optionally, tetrakis (hydroxymethylphosphonium) salt can be mixed with a nitrogen compound to form a soluble pre-condensate, before applied to the flame resistant textile. After applied to the flame resistance textile, the flame resistant textile may be further exposed to ammonia (unhydrous ammonia gas, for example) or to elevated temperature in an oven to cause further chemical reaction to cure or form an insoluble coating or finish on the textile. The elevated temperature may range from 50° C. to about 180° C. The flame resistant textile may be further exposed to hydrogen peroxide solution to oxidize at least some of the phosphonium-nitrogen product into a phosphinate-nitrogen product. The flame resistant textile may be washed in basic solution (such as caustic soda solution) and water before dried. The fire resistant coating is present at about 1-40% by weight of the first textile by weight, preferably 5-20% by weight.

Referring back to FIG. 1, the fire resistant composite 10 also contains a membrane 200 located on the lower side 100b of the first textile 100. “Membrane” in this application is defined to mean a solid or microporous, water-vapor permeable, and fluid impermeable material, typically a flexible membrane or layer. The membrane 200 contains polyurethane and optional additives. In one embodiment, the membrane consists essentially of polyurethane plus minor optional additives, meaning that the membrane contains at least 90% by weight polyurethane having optional minor additives with minor additives being less than about 20% (or 10%). The polyurethane membrane (note that these properties are of the whole membrane, not just the polyurethane in the membrane) has a softening temperature of least about 210° C. according to ASTM E2347 test method and is non-melting according to ASTM F2894 test method. There are wide range of polyurethane products and compositions. Extruded thermoplastic polyurethane are commonly used for applications due to its low costs and versatilities. Extruded thermoplastic polyurethane films have also been widely used for waterproof and moisture breathable applications. Extruded thermoplastic polyurethane membranes, however, melt into a low viscosity liquid at high temperature. There is a risk for high temperature melt to come into contact with human skin to cause serious burn injury in a high temperature resistant and flame resistant composite end use environment.

ASTM F2894 test method was often relied on to assess such risk, but ASTM F2894 test method is based on visual observation of melting after the composite cools down to room temperature, which can be subjective and sometime very difficult to determine if there is a melting and burn risk. ASTM E2347 test method is a quantitative and objective method, overcoming some of the deficiencies of ASTM F2894 for membrane suitable for this particular type of flame resistant textile composite. However, a high softening point according to ASTM E2347 test method doesn't necessarily mean the membrane material would not melt into a low viscosity hot liquid at high temperature.

A small group of polyurethanes have a softening point greater than 210° C. according to ASTM E2347 test method and exhibit non-melt visual behavior per ASTM F2894 test method when formed into membranes are found to avoid such melt liquid-related burn hazards. Polyurethane is made of a reaction product of aromatic and/or aliphatic isocyanate, and a mixture of polyols comprising polyethylene glycol (approximately 15-50% by weight of the polyurethane). Polyurethane comprising aromatic isocyanate and polyethylene oxide monomer units are preferred. Polyurethanes having high molecular weight (>50,000, or preferably >100,000 or >300,000) are preferred. Furthermore, the polyols may further include a polycarbonate polyol and/or a crosslinking/branching agent. The crosslinking agent may be an aromatic isocyanate included in the reaction mixture. The polyurethane is preferably a hydrophilic polyurethane, and optionally in microporous structure. By hydrophilic, the polyurethane swells reversibly when immersed in water, but does not dissolve in water. The welling ratio (weight of fully swollen membrane divided by dried same membrane at room temperature) is about 10-500%, or preferably, 20-150%. Upon drying at room temperature or at elevated temperature, the polyurethane returns virtually to its original dimension. When certain portion of the water soluble polyethylene glycol monomer is not fully reacted into the polyurethane, or there are significant portion of lower molecular fraction in the polyurethane, repeated swelling and drying cycles will cause loss of materials and/or measurable membrane shrinkage. Excess residue internal stress from membrane casting process may also cause membrane shrinkage after swelling and drying recycles. Membrane shrinkage can lead to internal material stress in the fire resistant textile composite and decreased product performance after repeated laundry cycles. The polyurethane membrane suitable for the fire resistant textile composite exhibits highly consistent reversible swelling and recovery cycle with virtually no changes in dimension. In one embodiment, the membrane exhibited less than 5% shrinkage in any of the membrane's sheet plane dimensions (such as in machine direction and cross-machine direction of the manufactured membrane) after 5 cycles of repeated immersion in room temperature water and drying at 70° C. for half an hour in a convection oven, or in a regular home washing and tumble drying cycle. The film may be placed in a water permeable laundry bag to prevent tearing in a home washing and drying machines to conduct the shrinkage test. In another embodiment, the membrane exhibited less than 3% shrinkage after such 5 repeated water immersion and drying cycles, or laundry recycles. In a preferred embodiment, the membrane exhibited less than 2% shrinkage in such 5 repeated water immersion and drying cycles or laundry cycles. In yet another embodiment, the membrane exhibited less about 1% shrinkage after 5 repeated water immersion and drying cycles or laundry cycles. Furthermore, the polyurethane membrane has an elongation at break of at least 80-600%.

In one embodiment, the membrane 200 comprises a high molecular weight (with molecular weight greater than 50,000 or preferably >100,000) or crosslinked polyurethane (comprising polymer crosslinking covalent bonds within the polymer chemical structure). An aromatic or aliphatic isocyanate or a polyol or polyamine having 3 or greater functionality (reactive groups), may be included to create crosslinking chemical bonds in the polyurethane. The membrane 200 and the fire resistant textile composite maintains liquid water barrier property after exposed to high temperatures, up to 220 C. The fire resistant textile composite including the membrane 200 was placed inside a lab convection oven at 220 C for 5 minutes. After the high temperature exposure, the textile composite was tested for water barrier property, according to AATCC 127 method at 2 Psi water pressure. No water penetration was detected after for 1 minute. While most thermoplastic polyurethane films are sensitive to (for lack of liquid barrier property) at least one of the following chemical liquids: sulfuric acid (37%), gasoline solvent, hydraulic fluid or hypochlorite bleach (oxidizing chemicals), the fire resistant composite 10 comprising the membrane 200 exhibits excellent barrier property to all of the above chemical liquids, under ASTM F903 (Procedure C), Standard Test Method for Resistance of Materials Used in Protective Clothing to Penetration by Liquids, even after the fire resistant textile composite being through 5 laundry cycles.

Preferably, the polyurethane membrane contains less than about 0.1% by weight fluorine or does not include an intentionally added organic fluorine-containing compound. In another embodiment, the fire resistant composite contains less than about 0.1% by weight organic fluorine. In a further embodiment, the fire resistant textile composite contains less than about 50 ppm (parts per million), less than 10 ppm, or less than 5 ppm of organic fluorine. In particular, the polyurethane membrane and the flame resistant textile composite are free of an expanded polytetrafluoroethylene support substrate commonly used in rainwear textiles and garments. At least one portion or one layer of the polyurethane membrane is non-porous and liquid water will not penetrate the membrane at a pressure of 5000 mm water column per AATCC Test Method 127.

Preferably, the membrane 200 is a single layer, monolithic film. In another embodiment the membrane contains multiple layers such as by co-cast or coating layers. In another embodiment, the fire resistant composite contains more than one membrane, where the membranes may be adhered together optionally using an adhesive or may have another textile layer between them.

The polyurethane membrane in one embodiment, has an average thickness of between about 8 and 50 micrometers. In another embodiment, the polyurethane membrane has an average thickness of between about 12 and 40 micrometers. For composites with textiles on only one side of the membrane it may be desirable to have a thicker membrane and for composites that have textiles on both sides of the membrane, it may be desirable to have a thinner membrane. In one embodiment, the polyurethane membrane is solvent cast and is applied to the first textile as a standalone film. In other embodiments, the polyurethane may be formed directly on the first textile as a coating (solvent or extrusion coating). Preferably, the polyurethane membrane contains less than 0.01% by weight of the fire retardant composition because the fire retardant composition is applied to the first textile, not to the composite.

In one embodiment, the polyurethane membrane has an average weight of less than about 50 GSM, more preferably less than about 40 GSM, or less than 30 GSM (grams per square meter). When it comes to comfort of the wearer and depending on the end-use, lower weights of the membrane and textile that it is laminated to are preferred against the performance. The combination of the membrane and the textile structure proposed in this invention takes both comfort and performance into consideration.

In one embodiment, the fire resistant composite has a moisture vapor transmission rate (MVTR) of the fire resistant composite as measured by the test method JIS L1099-B1 is greater than about 300 g/m²/24 h, (prefer >700, 1000), it has been found that this range provides a textile that has good breathability. In another embodiment, the fire resistant composite has a moisture vapor transmission rate (MVTR) of the fire resistant composite as measured by the test method ASTM E96B for the water inverted version being greater than 200 g/d*sq·m (>300 preferred). In another embodiment, the fire resistant composite has a hydrostatic head as measured by the test method AATCC 127 is greater than about 5,000 (mm H₂O), more preferably greater than about 14,000 (mm H₂O), which has been shown to give good rainproof and waterproof characteristics.

In one embodiment, the polyurethane membrane contains an opacifying agent having UV light absorbing property. In one embodiment, the opacifying agent is titanium dioxide or carbon black, at sufficient amount so that the textile substrate is not readily visible when view from the membrane side. The amount of opacifying agent is in the range of 2-50% by weight, preferably 5-30%. The titanium dioxide is preferable in the form of particles having an average particle size of about 0.1-10 microns, having surface coating comprising silica and alumina to passivate the titanium dioxide against adverse photodegradation of polyurethane membrane.

The UV opacifying agent has a preferably strong light absorption in the UV region of about 200-400 nm wavelength. TiO₂ and carbon black are both considered good UV absorbers. Other UV absorbs include, but are not limited to, benzophenones, benzotriazoles, and triazine-based organic UV absorbing agents. In one embodiment, the polyurethane membrane contains an UV absorbing agent (such as TiO₂ and carbon black) having both UV absorbing and opacifying properties. In another embodiment, the polyurethane membrane contains an organic UV absorbing agent having UV absorption (such as benzophenones, benzotriazoles and triazines) and an inorganic opacifying agent having opacifying properties (such as calcium carbonate, Kaolin clay, silica, alumina, aluminum silicate, and magnesium aluminum silicate).

In one embodiment, the polyurethane membrane comprises a phosphor-based flame retardant. This may be the only added phosphor-based flame retardant in the composite (meaning that it is not present in the textile layer, adhesives, etc) or may be in combination with some or all of the layers containing the phosphor-based flame retardant. The phosphor-based flame retardant used in the membrane is of the same materials, and chemical properties as the phosphor-based flame retardant described in relation to the FR coating on the first textile.

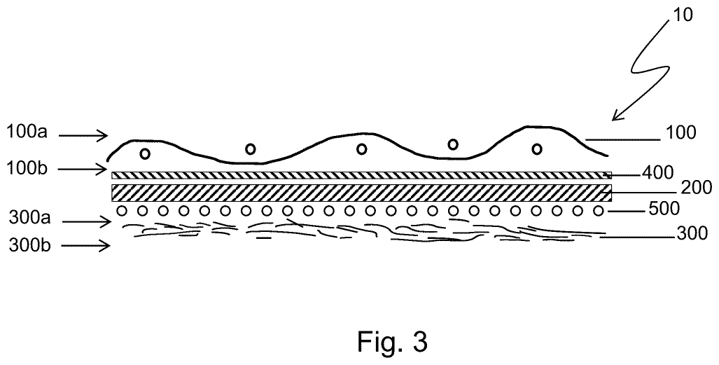

In one embodiment, the membrane is directly adhered to the first textile, meaning that the two are in direct physical contact without any other layers or materials between them. In another embodiment, there is a first adhesive layer 400, shown in FIG. 3, or other tie layer between the membrane 200 and the first textile layer 100. This adhesive layer can be any suitable adhesive including a hot melt adhesive, binding fibers, pressure sensitive adhesive or the like. This adhesive layer serves to adhere the composite's individual component layers together so that performance is sustained after multiple washing cycles.

The adhesive layer(s) may be any suitable material, but in one preferred embodiment are of the same class of polymer as the first textile or membrane 200 so that the composite may be more easily recycled. The first adhesive layer is preferably at a low weight as to no little additional weight or thickness to the composite 10. The adhesive layer may be continuous or discontinuous. The adhesive layer preferably contains a polyurethane, polyamide, polyester, ethylene-vinylacetate copolymer, ethylene-acrylic acid copolymer or a polyolefin. A polyurethane is preferred. A moisture cure hot melt polyurethane comprising reactive isocyanate chemical groups are further preferred. Reactive aromatic isocyanate chemical groups in the polyurethane adhesive tends to have faster reaction and curing speed to afford strong adhesive bonds is preferred. Nonlimiting examples of reactive aromatic isocyanate include TDI (toluenediisocyanate), polymeric TDI, MDI (4,4″-methylene di(phenylisocyanate)), and polymeric MDI. Reactive MDI, polymeric MDI and their derivatives having reactive isocyanate group are preferred. The hot melt adhesive may contain about 2% to 10% isocyanate composition, preferably, aromatic isocyanate, and most preferably MDI or a derivative of MDI. The adhesive can be applied to the textile substrate or to the polyurethane membrane as hot melt adhesive using a coating layer by any coating applicators (scrape coating, roll coating, . . . etc.) or by gravure rolls to form discontinuous adhesive dots. After the application of adhesive to either the textile substrate or membrane, the membrane and textile substrate are subsequently pressed together through a pair of nip rolls. The laminated textile composite is then allowed to cool down and/or adhesive is allowed to further react to establish a strong bond to tie the textile to the membrane. In one embodiment, the adhesive is a moisture reactive hot melt adhesive, which can be applied to the membrane or textile substrate as a liquid at an elevated temperature. When the laminated composite is formed as described above, the adhesive cools down into a solid to hold the textile and membrane together. The adhesive further reacts with moisture in the air to form a strong bond between the textile substrate and the membrane. In another embodiment, the adhesive layer may contain a polyacrylic resin.

In one further embodiment, the materials of the first adhesive layer and/or the second adhesive layer are thermoset polymers. The adhesive layers are preferably applied as hot melt materials that then react and cure into thermoset materials through a reaction with the moisture in the air after being incorporated into the fire resistant textile composite as described above. Preferably, an aromatic isocyanate, such as MDI or an MDI derivative (oligomer or polymer containing an aromatic isocyanate reactive group), is included in the hot melt composition to react with moisture and/or other components in the hot melt to cure into a thermoset adhesive. The thermoset adhesive thus will not melt at elevated temperatures. The fire resistant textile composite will not delaminate or separate into individual layer when exposed to high temperatures due to the thermosetting characteristics of the adhesive that glues different layers together.

In one embodiment, the first adhesive contains a phosphor-based flame retardant. Preferably, the phosphor-based flame retardant contains an organic or inorganic phosphor element containing chemical compound. In one embodiment, the organic or inorganic phosphor element containing chemical compound is selected from the group consisting of elemental phosphorus, organic phosphate esters, organic phosphinates, organic phosphonates, organic phosphites, and mixtures thereof. In another embodiment, the phosphor-based flame retardant is an organic phosphate selected from the group consisting of acyl and aryl cyclic phosphates, Isopropyl phenyl diphenyl phosphate, resorcinol bis(diphenyl phosphate), triphenyl phosphate, bisphenol A bis(diphenylphosphate), trioctyl phosphate, cresyl diphenyl phosphate, tricresyl phosphate, trixylyl phosphate, and mixtures thereof. In another embodiment, the phosphor-based flame retardant is a phosphinate selected from the group consisting of aluminum diethylphosphinate, zinc diethylphosphinate, and mixtures thereof. In another embodiment, the phosphor-based flame retardant is phosphoric acid, 1,3-phenylene tetrakis (2, 6-dimethylphenyl) ester. (CAS 139189-30-3). The phosphor-based flame retardant is present in the adhesive at weight percentage of about 10% to 60% by weight, preferably 25-50% by weight. The phosphor-based flame retardant is particularly compatible with the adhesive, such that at up to 50-60% loading in the adhesive, there is no significant loss of durable bonding of the first textile 100 to the membrane 200. The phosphor-based flame retardant is preferably water insoluble. It is also preferably uniformly mixed or dispersed in the adhesive, and well encapsulated inside the adhesive. The flame retardant thus will not be lost easily in repeated laundry cycles and normal apparel uses.

Preferably, the first adhesive layer is discontinuous to allow for high moisture transport rate through the composite. In one embodiment, the adhesive is applied using a gravure roller with a pattern, which may be in one example a discontinuous dot matrix pattern. The adhesive may be applied to the textile layer 100 or the membrane 200.

Referring to FIG. 3, the composite 10, in some embodiments, may also contain an additional textile 300. In one embodiment, additional textile 300 is a nonwoven textile 300. This nonwoven textile 300 has an upper surface 300a and a lower surface 300b. The nonwoven textile is oriented in the composite such that the upper surface 300a of the nonwoven textile 300 faces and is adhered to the membrane 200 on the side of the membrane opposite to the first textile 100.

In some embodiments, additional textile 300 is a knit textile comprising a yarn made of one or more of flame resistant staple fiber(s). This knit textile 300 has an upper surface 300a and a lower surface 300b. The knit textile is oriented in the composite such that the upper surface 300a of the knit textile 300 faces and is adhered to the membrane 200 on the side of the membrane opposite to the first textile 100.

The nonwoven textile is a spunlace nonwoven textile and is very light weight. Spunlace nonwoven may be made by a wet (by means of an array of high pressure water jets, sometimes called hydroentangle process, for example) or dry bonding process of fibrous webs made by either carding, airlaying or wet-laying of staple fibers. Preferably the nonwoven textile has an areal weight of between about 0.2 and 2 oz/yd². The nonwoven textile contains a plurality of staple fibers being at least about 40% by weight inherently flame resistant fibers and having an average staple length of between about 20 and 120 mm (preferably, 20-60 mm). Fiber length greater than 20 mm allows effective inter-entanglement of fibers in the web to provide sufficient mechanical strength of nonwoven web to provide mechanical reinforcement of the membrane and textile composite structures. When fiber length is greater than 120 mm, the nonwoven textile may have too little elongation or cause the textile composite to be very stiff. In one embodiment, the nonwoven textile 300 has a thickness of between about 0.05 and 0.55 mm (preferably between 0.15 mm and 0.40 mm) and in another embodiment, the nonwoven textile 300 has a thickness of between about 0.15% and 1.5% (preferably between 0.3% and 1%) of the average fiber length of the staple fibers in the nonwoven textile 300. Thickness ranges higher or lower than the above range were found to be less effective in provide wash and abrasion durable reinforcement of the membrane layer of the textile composite.

The types and amounts of fibers within the nonwoven textile and knit textile are the same as listed for the first textile 100. More preferably, the nonwoven textile and knit textile 300 contains at least about, 40%, 60%, 70%, 80%, or 90% by weight of inherently flame resistant fibers. These high amounts of inherently flame resistant fibers help make the flame resistant composite resist flames and fire. In a preferred embodiment, the nonwoven textile and knit textile 300 contains at least about 60% by weight aramid fibers, more preferably at least about 80% by weight aramid fibers. In one embodiment, the aramid fibers in the nonwoven textile and knit textile 300 contain between about 20 and 60% by weight meta-aramid fibers and about 40 and 80% by weight para-aramid fibers. In another embodiment, the aramid fibers in the nonwoven textile and knit textile 300 contain between about 20 and 40% by weight meta-aramid fibers and about 50 and 70% by weight para-aramid fibers.

The nonwoven textile and knit textile 300 are adhered to the membrane 200 in any suitable method including binder fibers (either separate to or part of the nonwoven textile 300 or knit textile 300) or a hot melt adhesive. Preferably, the composite 10 contains a second adhesive layer located between the polyurethane membrane and the nonwoven textile or knit textile, where the second adhesive layer contains a discontinuous coating of a hot melt adhesive in a pattern of discrete elements. The discrete elements could be regular or random and preferable over about 10 to 80% (preferably 20% to 50%) of the geometric surface area (as if the nonwoven textile surface is a solid plane, by the term “geometric surface area”) of the upper surface 300a of the nonwoven textile 300 or knit textile 300. The discrete elements are preferably dots having a generally round shape but could also be amorphous, lines, indicia, squares, or other shapes. The average distance between one element and a neighboring element is less than 1/10^{th} the average fiber length of the fibers in the nonwoven textile and in the knit textile. Typical average distance between one element and a neighboring element is between 0.5 mm and 5 mm, preferably between 0.8 mm to 3 mm. Staple fiber length in the nonwoven textile and knit textile typically are between 10 mm to 120 mm, preferably 25 mm to 70 mm. The nonwoven textile and knit textile generally have a thickness of 0.1 mm to 1.5 mm, preferably 0.2 mm to 1 mm, and more preferably between 0.3 mm to 0.7 mm. The ratio of average fiber length of the nonwoven and knit textile to nonwoven textile and knit textile thickness is between about 20 and 7000, preferably between 50 and 250, more preferably between 70 and 150. Since the nonwoven textile and knit textile has a relatively small thickness and a small thickness to fiber length ratio, the staple fiber in the nonwoven textile and knit textile is mostly oriented in the sheet or plane direction of the membrane. With the adhesive elements spaced more densely than the fiber length, most of the fibers in the nonwoven and knit textile have a great chance of being each bonded to multiple adhesive elements. When sufficient amounts of fibers in the nonwoven and knit textile are each bonded by the adhesive elements at multiple points, the fibers in the nonwoven structure and knit textile are less likely to be dis-entangled by abrasion or in repeated laundry cycles. It is also found that when individual fiber in the nonwoven or knit textiles are bonded through multiple points onto the neighboring membrane layer, a more effective and durable reinforcement of the membrane can be formed. The thickness to average fiber ratio along with small nonwoven and knit textile thickness enable the use of a textile layer at a very low weight while providing highly durable reinforcement of the membrane. The second adhesive layer can be created any suitable manner, preferably by gravure printing or coating.

In one embodiment, the second adhesive contains a phosphor-based flame retardant (preferably both the first and second adhesive layers contain a phosphor-based flame retardant). Preferably, the phosphor-based flame retardant contains an organic or inorganic phosphor element containing chemical compound. In one embodiment, the organic or inorganic phosphor element containing chemical compound is selected from the group consisting of elemental phosphorus, organic phosphate esters, organic phosphinates, organic phosphonates, organic phosphites, and mixtures thereof. In another embodiment, the phosphor-based flame retardant is an organic phosphate selected from the group consisting of acyl and aryl cyclic phosphates, Isopropyl phenyl diphenyl phosphate, resorcinol bis(diphenyl phosphate), triphenyl phosphate, bisphenol A bis(diphenylphosphate), trioctyl phosphate, cresyl diphenyl phosphate, tricresyl phosphate, trixylyl phosphate, and mixtures thereof. In another embodiment, the phosphor-based flame retardant is a phosphinate selected from the group consisting of aluminum diethylphosphinate, zinc diethylphosphinate, and mixtures thereof. In another embodiment, the phosphor-based flame retardant is phosphoric acid, 1,3-phenylene tetrakis(2, 6-dimethylphenyl) ester. (CAS 139189-30-3). The phosphor-based flame retardant is present in the second adhesive at weight percentage of about 10% to 60% by weight, preferably 25-50% by weight. The phosphor-based flame retardant is particularly compatible with the adhesive, such that at up to 50-60% loading in the adhesive, there is preferably no significant loss of durable bonding of the nonwoven or knit textile to the membrane 200. The phosphor-based flame retardant preferably is water insoluble. It is also preferably uniformly mixed or dispersed in the adhesive, and well encapsulated inside the adhesive. The flame retardant thus will not be lost easily in repeated laundry cycles and normal apparel uses.

In one embodiment, the fire resistant composite contains, in order, the first textile, the first adhesive layer, the polyurethane membrane, second adhesive layer, and the nonwoven textile (all layers and materials for each component described above), where the first textile contains a fire resistant coating which contains a phosphor-based flame retardant.

In one embodiment, the fire resistant composite contains, in order, the first textile, the first adhesive layer, the polyurethane membrane, second adhesive layer, and the nonwoven textile (all layers and materials for each component described above), where the first textile contains a fire resistant coating which contains a phosphor-based flame retardant.

In another embodiment, the fire resistant composite contains, in order, the first textile, the first adhesive layer, the polyurethane membrane, second adhesive layer, and the nonwoven textile (all layers and materials for each component described above), where the first textile contain a fire resistant coating which contains a phosphor-based flame retardant and the first adhesive layer contains a phosphor-based flame retardant.

In another embodiment, the fire resistant composite contains, in order, the first textile, the first adhesive layer, the polyurethane membrane, second adhesive layer, and the nonwoven textile (all layers and materials for each component described above), where the first textile contain a fire resistant coating which contains a phosphor-based flame retardant and the first adhesive layer and polyurethane membrane contain a phosphor-based flame retardant.

In another embodiment, the fire resistant composite contains, in order, the first textile, the first adhesive layer, the polyurethane membrane, second adhesive layer, and the nonwoven textile (all layers and materials for each component described above), where the first textile contain a fire resistant coating which contains a phosphor-based flame retardant and the first adhesive layer, polyurethane membrane, and the second adhesive layer contain a phosphor-based flame retardant.

In another embodiment, the fire resistant composite contains, in order, the first textile, the first adhesive layer, the polyurethane membrane, second adhesive layer, and the nonwoven textile (all layers and materials for each component described above), where the first textile and the nonwoven textile contain a fire resistant coating which contains a phosphor-based flame retardant and the first adhesive layer, polyurethane membrane, and the second adhesive layer contain a phosphor-based flame retardant.

In another embodiment, the fire resistant composite contains, in order, the first textile, the first adhesive layer, the polyurethane membrane, second adhesive layer, and the nonwoven textile (all layers and materials for each component described above), where the first adhesive layer and the second adhesive layer contain a phosphor-based flame retardant.

In another embodiment, the fire resistant composite contains, in order, the first textile, the first adhesive layer, the polyurethane membrane, second adhesive layer, and the nonwoven textile (all layers and materials for each component described above), where the first adhesive layer, polyurethane membrane, and the second adhesive layer contain a phosphor-based flame retardant.

In another embodiment, the fire resistant composite contains, in order, the first textile, the first adhesive layer, the polyurethane membrane, second adhesive layer, and the nonwoven textile (all layers and materials for each component described above), where the first textile contains a fire resistant coating which contains a phosphor-based flame retardant and polyurethane membrane contains a phosphor-based flame retardant.

In another embodiment, the fire resistant composite contains, in order, the first textile, the first adhesive layer, the polyurethane membrane, second adhesive layer, and the nonwoven textile (all layers and materials for each component described above), where at least one of the textiles and/or layers contain a phosphor-based flame retardant.

In one embodiment, the composite is made by the process of forming a first textile having an upper and lower side. The first textile is then treated with the fire resistant coating. The membrane is attached to the lower side of the first textile by an optional (first) adhesive layer.

The process continues by optionally creating a nonwoven or knit textile and then adhering the nonwoven textile to the membrane on the opposite side to the first textile. The nonwoven is preferably made by a spunlace process, preferably by a hydroentangle process. The nonwoven and knit textile may be optionally coated or treated with the fire resistant coating described above. The nonwoven is laminated to the membrane by applying an adhesive layer between the membrane and the nonwoven through adhesive application process described above.

In another series of embodiments, the invention provides a garment comprising one or more pieces of the fire resistant composite of the invention. The one or more textile/fabric pieces can be joined (e.g., sewn) together in such a way as to enclose an interior volume, which interior volume is intended to be occupied by a wearer or at least a portion of the anatomy of a wearer.

When the fire resistance composite pieces are joined together by sewing, an adhesive tape may be applied over the seam to provide liquid tight seal to prevent water, hazardous chemical liquids, biological liquid (such as bodily fluids) from penetrating through the sewn seam under pressure. Fluid tight seal herein means that when a liquid such as water is pressed against the seam area from one side of a seamed panel at about 2 Psi (pound force per square inch) pressure for 15 second, no liquid penetration or leakage of the liquid can be observed on the opposite side of the seamed panel. The adhesive tape may contain a film backing layer and a tape adhesive layer disposed over the backing layer on one side, where the tape adhesive layer is intimate contact with the first textile or preferably the additional textile layer to cover and seal the seam area.

The adhesive tape may be applied over the sewn seam under pressure and at a temperature close to or greater than the softening point of the adhesive such that the tape adhesive layer softens or melts to form a liquid tight seal over the seam area. The adhesive tape may contain an additional tape textile layer disposed over the film backing layer on the opposite side of the tape adhesive layer. The film backing layer may contain an elastomeric material having a melting or softening point greater than 140° C., and the tape adhesive layer may have a softening point between about 50° C. and 140° C. according to ASTM E2347 test method mentioned above. In one embodiment the film backing layer contains a polyurethane having a softening point greater than 140° C., preferably higher than 160° C. In a preferred embodiment, the film backing layer contains a polyurethane having a softening point greater than 210° C. according to ASTM E2347 and is non-melting according to ASTM F2894 test method. In another embodiment, the tape adhesive layer contains a polyolefin or a polyurethane. The adhesive layer has a thickness between about 50 micrometers to about 300 micrometers, preferably 80 to 200 micrometers, before the adhesive being applied to the garment.

Preferably the tape adhesive layer contains a polyolefin having a softening or melting point between about 60° C. and 120° C. The adhesive tape comprising polyolefin provides excellent durability to washing and in humid environments. The polyolefin may include homopolymers and copolymers of ethylene, propylene, butene, pentene, hexene, heptane, octene, nonene, styrene, isobutylene, butadiene, alpha-olefins, isoprene, and optionally minor amount (<about 10% by weight) of other non-olefin monomers such as vinyl acetate, (meth)acrylic acid, (meth)acrylates, maleic anhydride, and acrylamide. The polyolefin adhesive layer may also contain a small amount of other copolymers and additives. In one embodiment, a garment contains a plurality of the fire resistant textile composite pieces joined together by at least one sewn seam and an adhesive tape disposed over the sewn seam to provide liquid tight seal of the sewn seam, wherein the adhesive tape contains a backing film layer and a tape adhesive layer, the backing film layer contains a polyurethane having a softening point of greater than 140° C. and the tape adhesive layer contains a polyurethane or polyolefin having a softening point between 60° C. and 120° C. In yet another embodiment, the tape adhesive layer comprises a polyurethane adhesive having a softening point between 60 C and 120 C, preferably between 70 C and 1000. The polyurethane adhesive may include an aromatic polyurethane comprising a polyester polyol monomer unit. Aromatic polyurethane refers to polyurethane synthesize by reacting an aromatic isocyanate, such as MDI or TDI, with a polyol monomer. Suitable examples of such garments include, but are not limited to, shirts, jackets, vests, pants, overalls, coveralls, hoods, and gloves. Alternatively, the garment need not be constructed so that it encloses an interior volume. Rather, the garment can be constructed so that a wearer can securely fasten it to his or her body so that it covers and protects at least a portion of his or her anatomy. Suitable examples of such garments include, but are not limited to aprons, bibs, chaps, and spats. In one embodiment, the garment is an inner layer of a fire fighter jacket and/or pants.

The following examples further illustrate the subject matter described above but, of course, should not be construed as in any way limiting the scope thereof.

### EXAMPLES

### Example 1

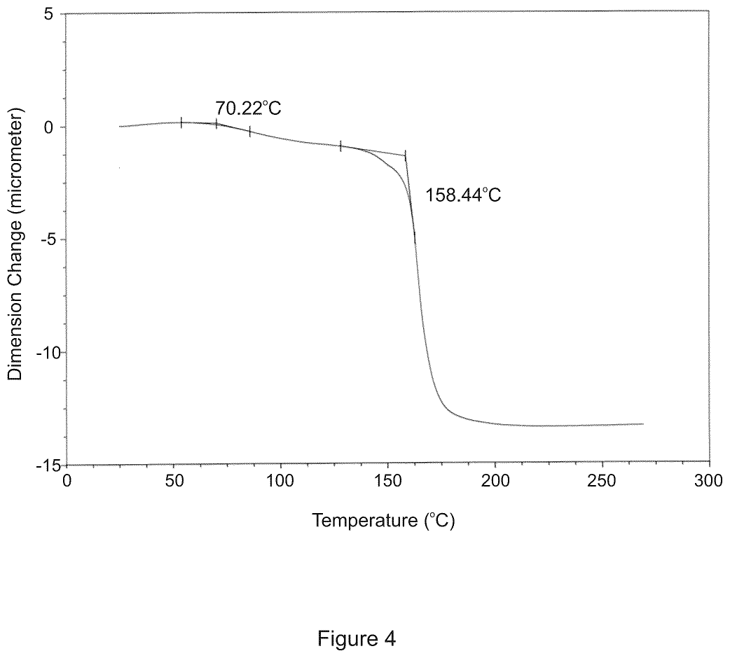

Several melt extruded thermoplastic hydrophilic polyurethane membranes (thermoplastic membranes) were heat pressed at 180-210° C. against a 3.5 oz/yd² aramid woven textile made of 92% meta-aramid, 5% para-aramid, and 2% antistatic Nylon fibers, to form waterproof breathable composites. All of the melt extruded hydrophilic polyurethane films have softening points around 150-180° C. according to ASTM E2347. The chart in FIG. 4 is a representative curve of displacement vs temperature obtained from one of the extruded membranes using ASTM E2347 test method, showing a softening point of about 158° C.

The composites were tested for heat resistance according to ASTM F2894 test method. After exposing to 500° F. heat for 5 minutes in a convection oven, all of the extruded films melt.

The composites were also tested for liquid penetration resistance according to ASTM F903, procedure C. The composites failed the barrier property against 37% sulfuric acid solution and a hydraulic fluid.

### Example 2

Cross-linking reaction is a typical method used to improve the heat resistance of a plastic material and to convert an otherwise thermoplastic material into a non-melting thermoset material. A crosslinked hydrophilic polyurethane membrane was obtained by dissolving a hydrophilic polyurethane resin having a softening point of about 160° C. in an organic solvent along with 2% by weight of a melamine formaldehyde crosslinker resin. The solvent mixture of hydrophilic polyurethane and crosslinker was first cast into a membrane, then dried and cured at 150° C. for 3 minutes. The film does not contain any pacifying agent. The cross-linked membrane still showed a softening point around 160° C.

When tested for melt resistance, the crosslinked film still exhibited visual melting/disintegration partially into a liquid according to ASTM F2894 test method. The addition of a cross-linking agent failed to make the membrane “non-melting” in the ASTM F2894 test method.

A UV light resistance test was carried out according to light degradation test method, ASTM G155. After 40 hours Xenon UV exposure, the polyurethane membrane in this example became very brittle with virtually no elasticity left. The film cracked readily when stretched slightly by hand.

### Example 3

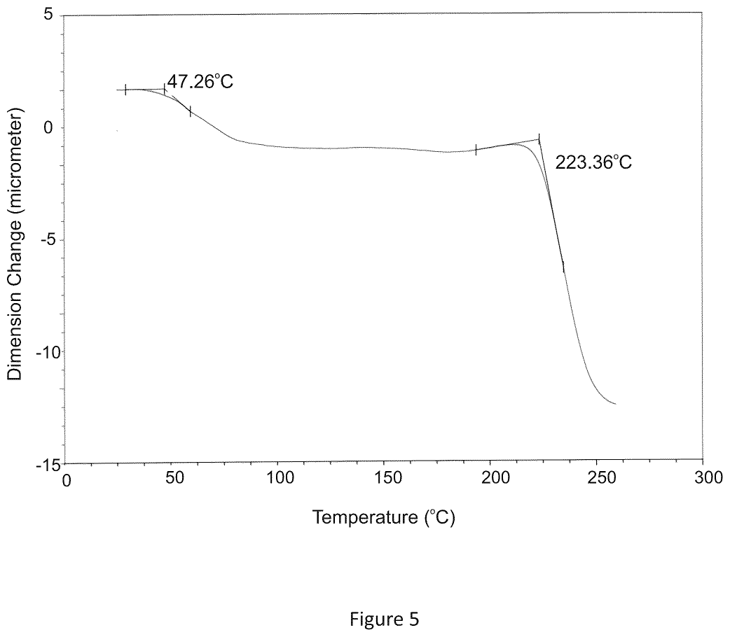

About 20% by weight titanium dioxide pigment having a passivating silica/alumina mix surface coating was incorporated into a hydrophilic polyurethane film solvent casting mixture, to produce an opaque, white colored polyurethane membrane at a thickness of about 20 microns. The polyurethane cast membrane has a softening point of about 223° C. The softening point was measured per ASTM E2347 standard test method using a 0.88 mm diameter penetration probe. Temperature was swept from room temperature to 260° C. at 3 degrees/minute. The displacement vs temperature curve obtained from the test is shown in FIG. 5.

When laminated to an aramid woven textile comprising 92% meta-aramid, 5% para-aramid and 2% antistatic Nylon fibers using a co-polyamide thermoplastic adhesive film, the composite exhibits waterproof and breathable properties having a hydrostatic pressure of >5 psi (pounds per inch) and moisture vapor transport rate of about 344 grams/meter²/24 hours, per ASTM E96 method B. When the composite is viewed from the membrane side, the textile is not readily visible due to the opaqueness of the pigmented membrane.

When tested for heat resistance according to ASTM 2894, the polyurethane membrane exhibited visual non-melting according to ASTM 2894. A slightly yellowed membrane remained on the surface of the aramid woven fabric without any visible sign of melting or cracking.

When tested for light resistance according to NFPA 1971 specified test method, ASTM G155, for 40 hours Xenon light exposure, the film has no noticeable discoloration or loss of elasticity or brittleness. The composite remained flexible and elastic when stretched by hand. Furthermore, moisture vapor transport rate tested under modified ASTM e96 method B remained virtually the same value as before UV exposure. The composite was also exposed to heat in a convection oven at 180° C. for 5 minutes. Again, moisture vapor transport rate didn't change materially after such high temperature heat exposure.

| | 23° C./50% RH, | 35° C./35% RH |
|---|---|---|
| | ASTM e96 | Modified ASTM e96 |
| | method B | method B |
| Control before heat & light | 344.19 | 2053 |
| exposure | | |
| After 180° C. 5 minutes heat | 346.51 | 1984 |
| exposure | | |
| After 40 hrs Xenon, ASTM | 365.12 | 2119 |
| G155, light exposure | | |

It was found that UV absorbing inorganic pigment dramatically improved the heat resistance and UV stability of the membrane simultaneous.

### Example 4

An aramid woven textile comprising 92% meta-aramid, 5% para-aramid and 2% antistatic Nylon fibers at about 3.3 ounces/yard² aerial weight textile was impregnated in a 20% by weight aqueous solution of a cyclic phosphate ester having a molecular structure represented by the following at weight pickup amount of about 60%.

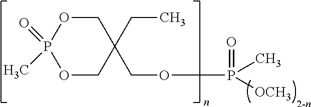

The textile was dried in a convection oven at 320° F. for about 3 minutes. The textile was then laminated to the polyurethane membrane described in in Example 3 (the polyurethane membrane containing TiO₂) to form a textile composite. The composite was tested for vertical flame according to ASTM D6413 method. The composite had a char length of about 3.5 inches. After just one wash and dry cycle using a home washer and dryer, the composite failed the same vertical flame test with more than 12 seconds afterflame.

A similar aramid textile and composite with the same polyurethane membrane as in example 3 was made except that the convection oven temperature was increased to 390° F. The textile passed the same vertical flame test with 3.8 inches char length after 5 wash and dry cycles with 0 second afterflame. Similar results were achieved when oven temperature of 375° F. was used.

Similar results were obtained when a hydrophobic polyacrylate water repellent resin emulsion was also included in the aqueous impregnation mixture at about 6% by weight. The hydrophobic polyacrylate treatment provides durable repellency to the aramid textile and may increase wash durability of the flame retardant treatment.

### Example 5

An aramid woven textile comprising 92% meta-aramid, 5% para-aramid and 2% antistatic Nylon fibers at about 3.3 ounces/yard² aerial weight was impregnated with a phosphonium-nitrogen flame retardant treatment mixture shown below at a wet pickup of about 55% based on the weight of the textile. The textile was then dried and cured in a convection oven at about 340° F. for 5 minutes. The dried textile was then immersed in a 3% hydrogen peroxide solution, then 2% sodium hydroxide solution for 1 minutes each, before rinsing thoroughly in water and dried. After the hydrogen peroxide immersion in an oxidation reaction, the phosphonium-nitrogen treatment on the textile was converted into a phosphinate-nitrogen flame retardant treatment. The phosphorus content in the textiles was about 1.3%.

### Phosphonium-Nitrogen Flame Retardant Treatment Mixture:

Tetrakis (hydroxymethyl)phosphonium chloride
precondensate with urea, 20% by weight;

| | |
|---|---|
| Urea | 3.5% by weight |
| Water | reminder |

The treated aramid textile above was laminated to the polyurethane membrane described in Example 3, using a hot melt moisture reactive polyurethane adhesive applied through a gravure roll in a discontinuous dot pattern, then tested according to ASTM 6413 vertical flame standard test method. When tetrakis(hydroxymethyl)phosphonium-urea precondensate concentration is increased to above 20% in the treatment mixture, the treated textile was noticeably stiff. When the tetrakis(hydroxymethyl)phosphonium-urea precondensate concentration is decreased to below 5%, the composite exhibits greater than 2 second afterflame time and longer than 4 inches char length while the textile is still soft.

Similar results were obtained when a hydrophobic polyacrylate water repellent resin emulsion was also included in the treatment mixture at about 6% by weight. The hydrophobic polyacrylate treatment provides durable repellency to the aramid textile and may increase wash durability of the flame retardant treatment.

The aramid woven textile of this example passed ASTM 6413 vertical flame test with less than 2 seconds afterflame and less than 4 inches char length without the above flame retardant treatment. When the aramid woven textile of this example was laminated to the polyurethane membrane of Example 3 to form a composite, the composite failed ASTM D6413 test with longer than 2 seconds afterflame.

### Example 6

A 3.3 ounce/yard2 aramid woven textile is made of 92% meta-aramid, 5% para-aramid, and 2% antistatic Nylon fibers. The aramid woven textile described was impregnated with a mixture of 20% Tetrakis(hydroxymethyl)phosphonium chloride pre-condensate with 3.5% urea, by weight in water at a wet pickup of about 55% based on the weight of the textile, as described in Example 6, to form a wash durable flame retardant treatment.

The flame retardant treated aramid woven textile is laminated to the polyurethane membrane mentioned in Example 3 above with a softening point about 223° C., using dot matrix pattern of moisture reactive hot melt polyurethane adhesive. The same dot matrix adhesive was also used to laminate a 0.9 ounces/yard² spunlace nonwoven made of 67% meta-aramid staple fiber and 33% para-aramid staple fiber, with an average staple fiber length about 52 mm. The distance between neighboring adhesive dots was about 0.8 mm. The thickness of the nonwoven textile was about 0.36 mm and had an areal weight of about 0.9 ounces/yard².

Before the nonwoven textile was laminated to the composite, the 2 layer composite made of the woven aramid textile and the polyurethane membrane (at a total weight of 4.3 oz/yd2) had a trapezoidal tear strength (ASTM D5587 method) of 8.5×9.0 pound force (filling by warp textile directions). After adhesively laminating the 0.9 ounces/yard² nonwoven textile to the 2 layer composite on the polyurethane membrane side, the 3 layer composite has trapezoidal tear strength of 16×22 pounds force, a substantially increase (2×) with a relatively small material weight added.

Visual inspection of the nonwoven side of the textile side under microscope revealed no openings or aperture greater than 2.5 mm in linear dimension, indicating good overall surface fiber coverage on the polyurethane film for mechanical reinforcement and protection of the membrane against abrasion and other mechanical loads.

After 5 repeated wash and dry cycles in a home washer and dryer, the above 3 layer composite has less loose un-tangled fiber or pilling appearance on the nonwoven side than a commercially available 4 ounces/yard² aramid spunlace nonwoven textile laminated to an ePTFE (expanded polytetrafluoroethylene) membrane using a similar dot matrix pattern of moisture reactive hot melt polyurethane adhesive. The 4 ounces/yard² nonwoven textile has a thickness of about 0.6 mm. A lighter weight nonwoven textile is usually less durable after repeated laundry recycles than a similar but heavier nonwoven textile. While laminated using similar adhesive and adhesive pattern, the light weight 0.9 ounce/yard² nonwoven textile layer in the composite was found to have surprisingly improved wash durability over a 4 ounces/yard2 heavier nonwoven textile similarly laminated to another support substrate. The ratio of neighboring adhesive dots distance to average fiber length, in combination with the small nonwoven thickness and weight are believed to be responsible for the surprising improvement.

Additionally, when a pencil eraser was rubbed against the nonwoven surface under pressure for about 1 minute, the light weight 0.9 ounces/yard² nonwoven in the above 3 layer composite had much less fiber fragments or loose fiber pulled/untangled to the surface than the 4 ounces/yard² otherwise similar nonwoven does. The 4 ounces/yard² nonwoven had almost 10 mm thick layer of loose fiber/fragment layer after the abrasion test while the 0.9 ounces/yard2 nonwoven had barely 2 mm thick layer of loose fiber.

### Example 7

A textile composite similar to what described in Example 6, except that the woven textile was not treated with the Tetrakis(hydroxymethyl)phosphonium chloride pre-condensate mixture. The resulting composite failed ASTM D6413 vertical flame test with >2 second afterflame and >4 inches char length.

All references, including publications, patent applications, and patents, cited herein are hereby incorporated by reference to the same extent as if each reference were individually and specifically indicated to be incorporated by reference and were set forth in its entirety herein.

### Example 8

A 3.3 ounce/yard² aramid woven textile was made of 92% meta-aramid, 5% para-aramid, and 2% antistatic nylon fibers. No flame retardant was applied to the woven textile.

The aramid woven textile is laminated to the polyurethane membrane mentioned in Example 3 above with a softening point about 223° C., using dot matrix pattern of a moisture reactive hot melt polyurethane adhesive including a phosphor-based flame retardant, phosphoric acid, 1,3-phenylene tetrakis(2, 6-dimethylphenyl) ester, present at about 30-50% based on the total weight of the adhesive. The adhesive add-on weight of on the laminate was about 5 to 10 grams per square meter. The 2-layer laminate of aramid woven textile and hot melt polyurethane adhesive including a phosphor-based flame retardant, however, failed the ASTM D6413 vertical flame test with >2 seconds afterflame and longer than 4″ char length.

The same dot matrix adhesive including a phosphor-based flame retardant was also used to laminate a 0.9 ounces/yard² spunlace nonwoven made of 67% meta-aramid staple fiber and 33% para-aramid staple fiber with an average staple fiber length about 52 mm, to the membrane side of the above 2-layer laminate to form a 3-layer laminate. The distance between neighboring adhesive dots was about 0.6 mm. The add-on weight of the adhesive used to laminate the nonwoven is about 4 to about 8 grams per square meter. The 3-layer laminate passed ASTM D6413 vertical flame test with 0 second afterflame time, and about 2-3 inches char length. After 5 home laundry in 140° F. hot water and tumble dry cycles, the 3-layer laminate also passed the vertical flame test with about 0 second afterflame time and about 3 inches char length.

It was un-expected that the 2-layer laminate in this example failed to pass the vertical flame test while the 3-layer laminate reliably passed the same vertical flame test. It was also unexpected that the adhesive including the phosphor-based flame retardant enabled the 3-layer laminate to pass vertical flame test before and after repeated laundry cycles at a low add-on weight of 10-18 grams per square meter, or at about 5-10% of the total weight of the 3-layer laminate. There were no added flame retardants in the woven textile, nonwoven or membrane layers.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein. “Essentially all”, if not defined in specific cases is defined to mean at least 98% by weight of the material. For example, if the membrane is essentially all polyurethane, this is defined to mean that the membrane contains at least 98% by weight polyurethane.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A fire resistant composite comprising:
a first textile having a first surface and a second surface and a plurality of interstices, wherein the first textile comprises at least about 40% by weight inherently flame resistant fibers;
a polyurethane membrane on the second surface of the first textile having a softening temperature of least about 210° C. according to ASTM E2347 test method and is non-melting according to ASTM F2894 test method, and wherein the polyurethane membrane comprises a phosphor-based flame retardant;
a first adhesive layer located between the polyurethane membrane and the first textile;
a nonwoven textile located on the polyurethane membrane opposite to the first textile, wherein the nonwoven textile is a spunlace nonwoven textile and comprises a plurality of staple fibers being at least about 40% by weight inherently flame resistant fibers and having an average staple length of between about 20 and 60 mm, wherein the nonwoven textile has an areal weight of between about 0.2 and 2 oz/yd²; and,
a second adhesive layer located between the polyurethane membrane and the nonwoven textile, wherein the second adhesive layer comprises a discontinuous coating of a hot melt adhesive in a pattern of discrete elements, wherein the average distance between one element and a neighboring element is less than 1/10^{th} the average fiber length of the fibers in the nonwoven textile.

2. The fire resistant composite of claim 1, wherein at least one of the first adhesive layer or the second adhesive layer comprise a phosphor-based flame retardant.

3. The fire resistant composite of claim 1, wherein both the first adhesive layer and the second adhesive layer comprise a phosphor-based flame retardant.

4. The fire resistant composite of claim 1, wherein the first textile comprises a fire resistant coating, wherein the fire resistant coating is located on at least the first surface of the first textile and in at least a portion of the interstices of the first textile, wherein the fire resistant coating comprises a phosphor-based flame retardant.

5. The fire resistant composite of claim 1, wherein the phosphor-based flame retardant is phosphorus-nitrogen compound or a phosphate ester compound.

6. The fire resistant composite of claim 5, wherein the phosphate ester compound is selected from the group consisting of a cyclic phosphate ester, an organic phosphinate, an organic phosphonate, phosphorus polyols and mixtures thereof.

7. The fire resistant composite of claim 5, wherein the phosphorus-nitrogen compound is selected from the group consisting of a phosphonium-nitrogen compound, a phosphonate-nitrogen compound, an organic phosphinate-nitrogen compound, a phosphate amide compound, a phosphine oxide-nitrogen compound, and mixtures thereof.

8. The fire resistant composite of claim 1, wherein the fire resistant composite comprises less than about 5 ppm by weight organic fluorine.

9. The fire resistant composite of claim 1, wherein the nonwoven textile has a thickness of is less than 1/10^{th} of the average fiber length of the fibers in the nonwoven textile.

10. The fire resistant composite of claim 1, wherein the first textile comprises at least about 80% by weight aramid fibers.

11. The fire resistant composite of claim 8, wherein the aramid fibers in the first textile comprise between about 70 and 98% by weight meta-aramid fibers and about 2 and 30% by weight para-aramid fibers.

12. The fire resistant composite of claim 1, wherein the first textile is a woven textile.

13. The fire resistant composite of claim 1, wherein the first textile has an areal weight of between about 2 and 8 oz/yd².

14. The fire resistant composite of claim 1, wherein the polyurethane membrane comprises aromatic isocyanate and polyethylene oxide monomer units.

15. The fire resistant composite of claim 1, wherein the polyurethane membrane is hydrophilic and has a swelling ratio in water of about 20-150%.

16. The fire resistant composite of claim 1, wherein the polyurethane membrane comprises an opacifying agent having a UV absorbing property.

17. The fire resistant composite of claim 1, wherein the polyurethane membrane has an average thickness of between about 10 and 32 micrometers.

18. The fire resistant composite of claim 1, wherein the polyurethane membrane has an average thickness of between about 30 and 50 micrometers.

19. The fire resistant composite of claim 1, wherein the nonwoven textile has a thickness less than about 1.5 mm.

20. The fire resistant composite of claim 1, wherein the second surface of the nonwoven textile layer comprises a hydrophilic coating.

21. The fire resistant composite of claim 1, wherein at least one of the first adhesive and the second adhesive comprise a thermoset polymer.

22. The fire resistant composite of claim 1, wherein both the first adhesive and the second adhesive comprise a thermoset polymer.

23. A garment comprising:
a plurality of fire resistant composites of claim 1 joined together by at least one sewn seam; and,
an adhesive tape disposed over the at least one sewn seam to provide liquid tight seal of the sewn seam, wherein the adhesive tape comprises a backing film layer and a tape adhesive layer, wherein the backing film layer comprises a polyurethane having a softening point of greater than 140° C., and the tape adhesive layer comprises a polyurethane or polyolefin having a softening point between 60° C. and 120° C.
